(19) United States
(12) Patent Application Publication
(10) Pub. No.: US 2003/0000793 A1
(43) Pub. Date: Jan. 2, 2003

(54) Pneumatic clutch with annular spring elements

(76) Inventors: Lane Brock, Wichita Falls, TX (US); Harold L. Jenkins, Comanche, OK (US)

Correspondence Address: John F. Booth, CRUTSINGER & BOOTH, Thanksgiving Tower, Suite 1950, 1601 Elm Street, Dallas, TX, 75201-4744, US

(21) Appl. No.: 09/895,769

(22) Filed: Jul. 2, 2001

(51) Int. Cl. F16D 25/04; F16D 13/52

(52) U.S. Cl. 192/70.28; 192/88 A

(57) ABSTRACT

A pneumatic clutch assembly comprises: a hub having a flange and a cylindrical wall, an inner plurality of longitudinally extending splines which project outwardly from the cylindrical wall, a longitudinally extending passage in the hub for receiving a shaft, and a plurality of driver plates slideably disposed on the splines and biased in a spaced relationship. A driving ring includes a plurality of inwardly extending splines on which a plurality of spaced circular friction plates are slideably disposed and positioned between the driver plates. A holding plate is superposed over the driver plates at the distal end of the hub to capture the driver plates and friction plates and secured to the hub by fasteners. An annular spring is positioned in each recess formed between two driver plates, and between the innermost driver plate and the flange. These springs maintain separation between the driver plates until the holding-plate fasteners are torqued down, compressing the annular springs. A pressure plate is interposed between the holding plate and the driver plates, and an inflatable tube is interposed between the pressure plate and the holding plate for selectively applying pressure to the driver plates, engaging and disengaging the clutch. To ease assembly of the clutch, selected splines on the hub extend substantially over an uncompressed bias dimension to the extent that the outermost driver plate is provided with sufficient spline contact to align the plate on the splines before the holding plate is secured to the hub.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### TECHNICAL FIELD

The present invention relates to improvements in a disk clutch mechanism. More particularly, this invention relates to a pneumatic disk clutch used in power transmission.

### BACKGROUND OF THE INVENTION

A disk clutch typically comprises a cylindrical drive hub, at least one annular driven plate, a plurality of annular driver plates and driven ring. All plates are concentrically disposed about the hub. For purposes of description the hub is identified as the drive element and the ring as the driven element. The drive and driven elements of a disk clutch of the types described herein could be reversed depending on the application. In other words the hub could be the output or driven element and the ring could be the input or driver element. A back plate and a holding plate attach to the hub at their respective ends in order to capture the driver plate or plates and the driven plates. The disk clutch also has some form of actuator that forces the plates into contact, causing the driver plates to hold the driven plate. The clutch operates on the friction force that develops when a driven plate is held between two driver plates. A common method of connecting the driver plates to the drive hub is by means of a plurality of splines, which force the driver plates to rotate with the hub but allow them to slide longitudinally unless otherwise restrained.

Proper alignment of the driver plates on the drive hub is critical to a properly functioning clutch. Proper alignment may be easily achieved in smaller clutches where the components are few and easy to handle, but in large torque applications, a series of large, heavy, driver and driven plates are employed. For example, in an oil drilling operation, the driver plates can weigh ninety pounds each and the holding plate that captures the driver plates and driven plates can weigh one-hundred-and-seventy pounds or more. As the number and weight of the individual plates increase, so does the difficulty of assembling the clutch.

Particularly in applications where in-place assembly may be required, as in the oil field, it is importance to be able to assemble a clutch quickly and with minimal assistance. Given the size and weight of the clutch's component parts, however, alignment of the driver plates on the splines of the drive hub while maneuvering the holding plate and various intermediate components is not easy. One solution is disclosed in U.S. Pat. No. 5,439,083, entitled CLUTCH, and issued on Aug. 8, 1995, which is by reference incorporated here in its entirety. This patent discloses using a plurality of springs to maintain separation between driver plates during assembly. Once all of the driver plates have been properly assembled, the holding plate is installed and its retaining fasteners tightened, thereby compressing the springs and moving the driving (and driven) plates into their operating configuration. A selected group of hub splines extend sufficiently in length so as to engage the driver plates and the holding plate before the fasteners are tightened, in this way enabling the plates to be properly aligned even with the springs in an uncompressed condition.

Despite the advantages of the improved design described above, the springs themselves are generally coiled springs that must be fitted into recesses formed in the driver plates during assembly. This configuration requires that each driver plate be carefully aligned so that the underlying spring is properly received into the recess, and where a spring is misaligned or jarred out of position, at remedial disassembly and reassembly will be required. Needed is a pneumatic clutch that allows for spring-biased alignment during assembly that does not have these shortcomings. The present invention provides for just such a clutch.

### SUMMARY OF THE INVENTION

A pneumatic clutch assembly is provided that includes: a cylindrical hub forming a longitudinally extending passage for receiving a drive shaft, a first plurality of longitudinal splines extending outwardly from the hub, a plurality of floating driver plates that engage these hub splines, a plurality of spaced friction (i.e., driven) plates that are positioned between the driver plates, a flange back plate secured to the hub at a first end and a holding plate secured to the hub at a second end so as to capture the driver plates and the friction plates between them. The driver plates are biased in a spaced relationship by annular springs such as a wave spring, Belleville spring, wire spring or resilient spring. that is interposed between the back plate and first (nearest) driver plate. A spacer ring is concentrically disposed about the hub between the end of the hub splines and the back plate. A split spacer ring is used for certain applications, such as retrofits, where separation of the back plate from the hub for spacer-ring installation may be difficult. Additional annular springs may be interposed between the driver plates to bias them into a spaced relationship as well. An annular driving ring is concentrically disposed about the driver and friction plates, and includes a second plurality of longitudinal splines. These driving-ring splines extend inwardly to engage the plurality of spaced friction plates. As should be apparent, the friction plates have an inner diameter large enough to avoid contact with the hub splines. In addition, the inner diameter is large enough to permit installation of the annular springs between the driver plates.

To apply pressure to the driver plates, an annular pressure plate is interposed between the holding plate and the outermost driver plate (i.e., the farthest from the back plate). An annular inflatable tube is interposed between the pressure plate and the holding plate for selectively applying pressure to the pressure plate, which in turn applies pressure to the driver plates and friction plates. During operation, the air tube is inflated so as to force these plates together. As the driver plates and friction plates are pushed together, sufficient friction forces develop between the plates to engage the clutch, that is, cause the friction plates to impart rotary motion to the driving ring. The air tube includes an inlet with a valve through which the air tube may be inflated or deflated to engage or disengage the clutch.

Whenever the clutch is assembled, the various plates are added, one at a time, in their proper order. To ease the alignment process during clutch assembly, selected hub splines extend substantially over an uncompressed bias dimension so that the outermost (last-assembled) driver plate is provided with spline contact sufficient to align the plate on the extended splines, notwithstanding that the substantially uncompressed annular springs are still holding the driver plates in a spaced relationship. When the other clutch components have been assembled, the holding plate is installed and its fasteners are secured to bring the holding plate into its operational, seated condition, a process that also compresses the annular springs and brings the driver plates and friction plates into closer proximity to each other.

### BRIEF DESCRIPTION OF THE DRAWINGS

The accompanying drawings are incorporated into and form a part of the specification to illustrate several examples of the present invention. These drawings together with the description serve to explain the principals of the invention. The drawings are only for the purpose of illustrating preferred and alternative examples of how the inventions can be made and used and are not to be construed as limiting the invention to only the illustrated and described examples. The various advantages and features of the present invention will be apparent from a consideration of the drawings in which:

FIG. 1 is a top plan view of the pneumatic clutch assembly according to the present invention;

FIG. 2 is a bottom plan view of the pneumatic clutch hub according to the present invention;

FIG. 3 is a cross-sectional view of the pneumatic clutch hub according to an embodiment of the present invention, taken along line A-A in FIG. 1;

FIG. 4 is an exploded cross-sectional view of a pneumatic clutch according to an embodiment of the present invention;

FIG. 5 is a cross-sectional view of the pneumatic clutch assembly taken along line A-A in FIG. 1, illustrating the clutch assembly with the threaded holding plate fasteners unsecured;

FIG. 6 is a cross-sectional view of the pneumatic clutch assembly taken along line A-A in FIG. 1, illustrating the clutch with the threaded holding plate fasteners tightened;

FIGS. 7a-7d are plan views of annular springs in accordance with the present invention;

FIG. 8a is a side view, and FIG. 8b is a plan view, of a spacer ring for use according to an embodiment of the present invention; and

FIG. 9a is a side view, and FIG. 9b is a plan view, of a split spacer ring for use an alternate embodiment of the present invention.

### DETAILED DESCRIPTION

The present invention is described by reference to drawings showing one or more examples of how the invention can be made and used. In these drawings, reference characters are used throughout the several views to indicate like or corresponding parts. The drawings are not necessarily to scale and the proportions of certain parts have been exaggerated to better illustrate details and features of the invention. The present invention will be described by referring to apparatus showing various examples of how the invention can be made and used. Like reference characters are used throughout the several views of the drawing to indicate like corresponding parts.

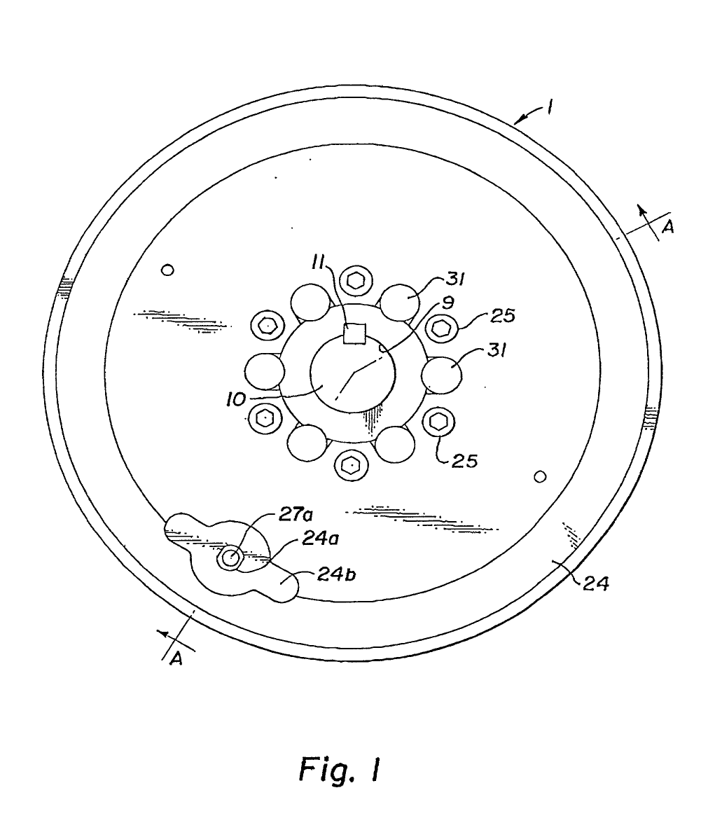

The preferred embodiments of the invention will now be described by reference to FIGS. 1-6 in which the annular springs are illustrated in the form of wave springs. Referring generally to FIGS. 1-6, the numeral 1 designates a pneumatic clutch assembly according to a preferred embodiment of the present invention. (Note that minor variation in the illustrated embodiment from drawing to drawing represent insubstantial differences unless otherwise noted.) In general, the clutch assembly is operable to selectively transfer rotational movement from drive shaft 10 (and hub 2) to driving ring 18 (or vice versa) by engaging the clutch components. Referring specifically to FIG. 3, which is a cross-sectional view of the pneumatic clutch hub 2 taken along line A-A shown in FIG. 1, hub 2 includes a cylindrical wall 8, a first end 3, and a second end 5. Hub 2 also includes two shoulders, 3a and 5a, to which back plate 6 and holding plate 24 (shown in FIG. 1) are respectively secured. Note that while hub 2 is described as having a first end and a second end, these are simply the locations where the back plate and the holding plate are secured, and there is no requirement that the actual hub not in some way extend past these ends, if it is desirable to do so. Annular back plate 6 has a substantially flat, inwardly facing surface 6a and is secured to shoulder 3a of hub first end 3 by threaded fasteners 7. Although a plurality of threaded fasteners 7 is preferred, in accordance with the present invention, other fastener types, or a single fastener, may also be used where appropriate. In an alternate embodiment (not shown), back plate 6 is an integrally formed portion of hub 2 (and hence “secured”). Cylindrical wall 8 defines a longitudinally extending passage 9 for receiving a drive shaft 10. Drive shaft 10 imparts rotary motion to cylindrical wall 8 (or is imparted with rotary motion) through a key 11. A plurality of longitudinally-extending spline teeth 12 (or simply “splines”) project radially outward from the cylindrical wall 8 of hub 2.

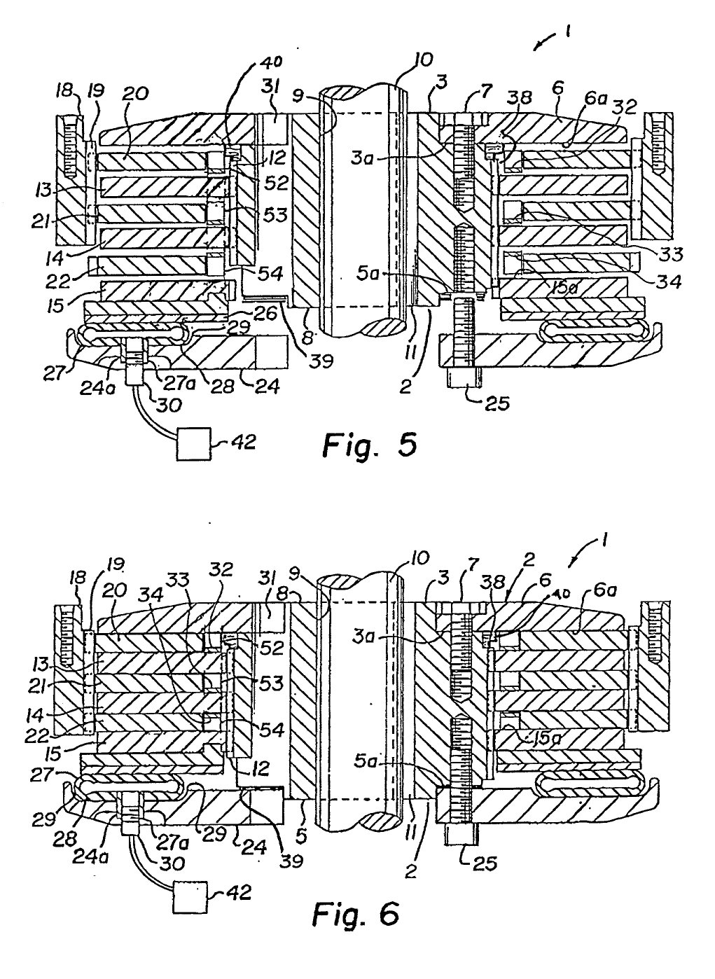

Referring now specifically to FIGS. 5 and 6, a plurality of spaced floating circular driver plates 13, 14, and 15 engage hub splines 12 and are concentrically disposed about the cylindrical wall 8. Floating driver plates 13, 14, and 15 are splined, that is, fixed in a radial fashion by, but free to move longitudinally along the splines 12. Thus, driver plates 13, 14, and 15 are slidable axially of hub 2. An annular driving ring 18 is concentrically disposed about the circumference of driver plates 13, 14, and 15 for imparting rotary motion to a piece of equipment. It should be noted, however, that in accordance with the present invention, rotary motion can be imparted to the equipment either through the shaft 10 or though the driving ring 18. Driving ring 18 includes a second plurality of longitudinally extending splines 19 (“ring splines”) and a means to secure the driving ring 18 to the equipment using or supplying the rotational motion (not shown).

The ring splines 19 face inwardly toward hub 2 and engage a plurality of spaced circular friction driven plates 20, 21, and 22 that are concentrically disposed about cylindrical wall 8. In the illustrated embodiment, friction plates 20, 21, and 22 are fixed in a radial fashion but are free to slide longitudinally along ring splines 19. Friction plates 20, 21, and 22 are interposed between driver plates 13, 14, and 15, with friction plate 20 positioned between back plate 6 and first driver plate 13, friction plate 21 positioned between the first driver plate 13 and a second driver plate 14, and friction plate 22 positioned between the second driver plate 14 and a third driver plate 15. (For the purposes of this disclosure, the various plates are numbered according to their order of assembly, with lower numbers therefore designating the innermost plates, that is, those closer to back plate 6.)

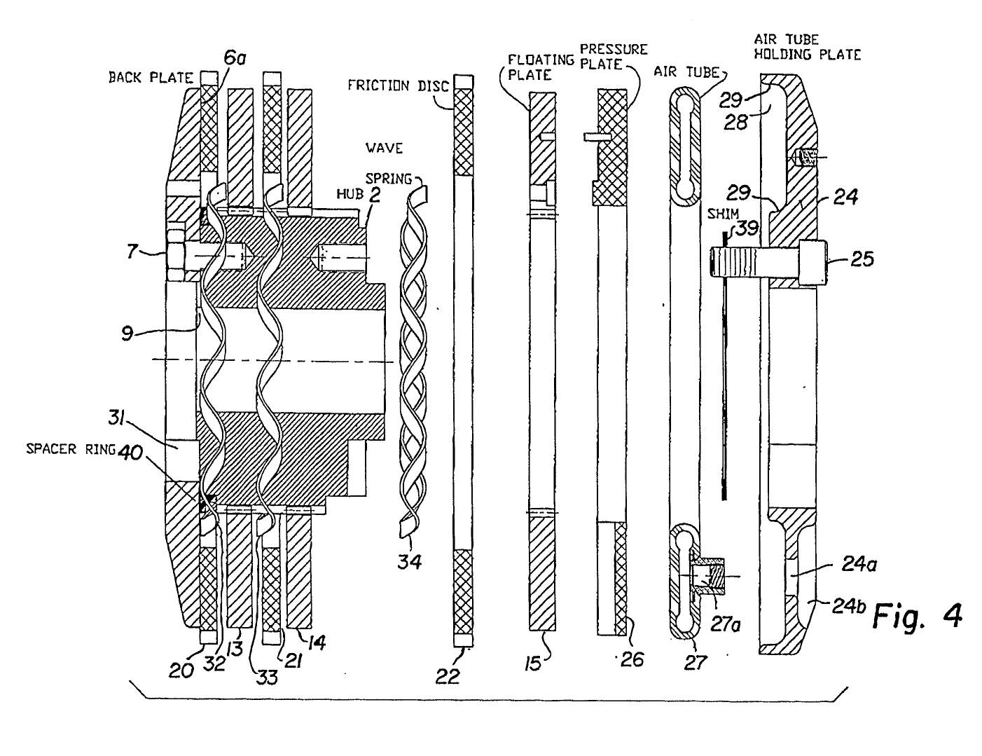

As illustrated in FIGS. 4, 5, and 6, in a preferred embodiment the driver plates 13, 14, and 15 and friction plates 20, 21, and 22 are captured on the hub 2 by an annular holding plate 24. Holding plate 24 is secured to the shoulder 5a of hub cylindrical wall 8 by threaded fasteners 25. Again, other types of fasteners may be used as well. In a preferred embodiment, shim 39 is disposed between shoulder 5a and holding plate 24. An annular pressure plate 26 is interposed between holding plate 24 and outermost driver plate 15 to apply pressure (collectively) to the driver plates 13, 14, and 15 and friction plates 20, 21, and 22. Annular pressure plate 26 is concentrically disposed about cylindrical wall 8. In addition, an inflatable tubular ring 27 is interposed between the pressure plate 26 and the holding plate 24 for selectively applying pressure to the driver plates 13, 14, and 15 and friction plates 20, 21, and 22. Holding plate 24 includes an annular recess 28 with vertically extending sides 29 to confine air tube 27 between holding plate 24 and pressure plate 26. Air tube 27 is inflated through inlet 27a and valve 30 which extend outwardly through an opening 24a in the holding plate 24. A pneumatic medium 42 is used to inflate tube 27. Note that although the present invention is described in terms of a pneumatic embodiment, suitable fluids other than air may also be used and such alternate embodiments are considered equivalent.

When air tube 27 inflates, driver plates 13, 14, and 15 are pushed along the splines 12 of hub 2 toward back plate 6. As the driver plates 13, 14, and 15 push against the flange 6 of the hub, friction plates 20,21, and 22 are held tightly between the driver plates. When the friction plates 20, 21, and 22 are held tightly between the driver plates 13, 14, and 15 friction forces develop between the respective plates, which allow the friction plates to impart the rotary motion of the driver plates to the driving ring 18. These friction forces, however, generate heat and can cause warpage in the driving plates and friction plates. To dissipate this heat, hub 2 includes cooling air passages 31. Cooling passages 31 extend through flange back plate 6, hub cylindrical wall 8, and holding plate 24 to provide an unobstructed air path through clutch assembly 1. The number and size of the cooling air passages 31 may be increased or decreased as the need arises.

FIG. 5 is a cross-sectional view of the pneumatic clutch assembly 1 taken along line A-A in FIG. 1, illustrating the clutch in an alignment configuration. Here, the term alignment configuration simply refers to that stage of clutch assembly where all of the driver plates and annular springs have been installed, but the springs are still substantially uncompressed. Annular springs are shown in FIG. 5 as wave springs 32, 33 and 34 in their substantially uncompressed form, producing an exaggerated spaced relationship between the driver plates 13, 14, and 15, and between driver plate 13 and back plate 6. The springs are referred to as “substantially uncompressed” notwithstanding any minor compression of the wave springs that may occur in the alignment configuration, caused for example by the weight of the plate stack even when the fasteners 25 securing holding plate 24 have not yet been completely installed. FIG. 5, then, shows driver plates 13, 14, and 15 in alignment configuration during assembly. The driver plates are biased into a spaced relationship by a plurality of circular wave springs 32, 33, and 34 (shown in FIG. 4) before fasteners 25 are secured (i.e., torqued to proper operational configuration) to seat holding plate 24 on shoulder 5a. Wave springs 32, 33, and 34 are disposed in gaps 52, 53, and 54 (shown in FIGS. 5 and 6), respectively, these annular gaps being the space between the hub splines 12 and the inner diameter of friction plates 20, 21, ands 22.

FIG. 6 is a cross-sectional view, taken along line A-A in FIG. 1, of the pneumatic clutch assembly in operational configuration, that is, the clutch with the holding plate fasteners tightened. Note that the term operational configuration refers to the clutch so assembled, regardless of whether it is engaged or disengaged. Note also that the terms substantially compressed will be used to refer to the state of the wave springs when the clutch is in the operational configuration, notwithstanding the fact that a small amount of additional compression will take place when the clutch is engaged.

Referring to FIG. 4, which is an exploded cross-sectional view of a pneumatic clutch according to an embodiment of the present invention, spring 32 is captured between back plate 6 and driver plate 13. Spring 33 is captured between driver plates 13 and 14, respectively. Likewise, spring 34 is captured between driver plates 14 and 15, respectively. (Note that for clarity, the wave springs are shown in full perspective rather than cut-away.) The interposition of the wave springs serves to maintain the driver plates in a spaced relationship (i.e. more so than if separated only by the friction plates). In the alignment configuration during assembly, this relationship is exaggerated until the holding plate fasteners are secured, seating holding plate 24 and placing the clutch into its operational configuration. During operation, the spatial relationship between driver plates exists to a much lesser extent until the plates are forced together by inflation of the air tube 27.

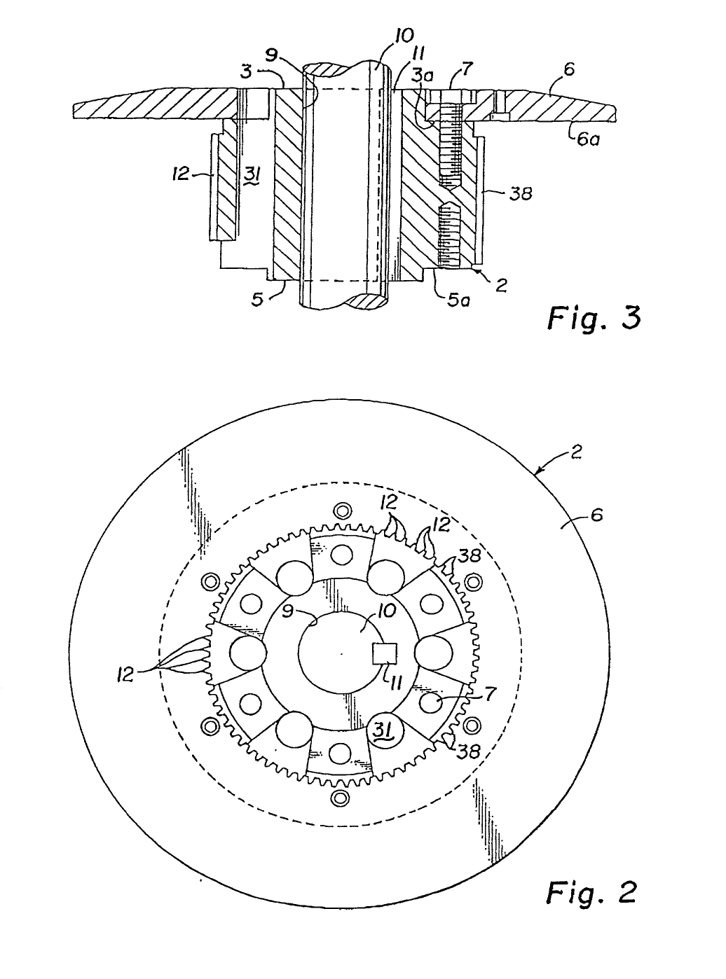

To ease the alignment process during assembly of the clutch 1, selected hub splines 38 extend substantially over an uncompressed bias dimension. As best shown in FIG. 5, where holding plate 24 is shown in an unseated position, the uncompressed bias distance is defined as the dimension along the hub between the first driver plate installed during assembly and the last, inclusive of their thickness, measured when the last driver plate is installed and the clutch is in the alignment configuration during assembly. The selected splines 38 are formed to extend substantially over the uncompressed bias dimension so that the outermost driver plate is provided with spline contact sufficient to align the plate on the extended splines, notwithstanding that the wave springs are still holding the driver plates in a spaced relationship. Note that “substantially over the uncompressed bias dimension” means that full contact throughout the width of each driver plate is not required. Furthermore, the uncompressed bias dimension may depend somewhat on whether the wave springs compress slightly during assembly, as mentioned above. Note that in the preferred embodiment, only a portion of the splines 12 are extended splines 38. To prevent obstruction of cooling passageways 31, splines 12 in the vicinity of cooling passageways are limited in length to the compressed axial dimension (as shown in FIG. 2, where shorter splines are denominated by the numeral 12). Referring now to FIG. 4, the compressed axial dimension is defined as the spline length necessary to operationally engage all of the driver plates—in this embodiment plates 13, 14, and 15—when springs 32, 33, and 34 are substantially compressed after holding plate 24 is seated and the clutch is in its operational configuration.

It can be appreciated that in-place assembly of the clutch is difficult. The holding plate 24 on a twenty-four inch clutch typically weighs one-hundred-and-seventy pounds or more, and driver plates 13, 14, and 15 each weigh ninety pounds or more. To assemble the clutch 1, driver plates 13, 14, and 15 have to be lined up on the splines 12, and then pressure plate 26, tubular ring 27 and holding plate 24 have to be aligned around the hub 2, while wave springs 32, 33, and 34 are disposed in gaps 52, 53, and 54. In view of the weight of the component parts of the clutch assembly 1, it can be appreciated that alignment of the driver plates 13, 14, and 15 on the splines 12 of the hub 2 while maneuvering the holding plate and various intermediate components is not an easy task. Selected spline extensions 38 allow alignment of the outermost driver plate 15 on splines 38 before the pressure plate 26, tubular ring 27, and holding plate 24 are fit-up for installation over driver plates 13, 14, and 15.

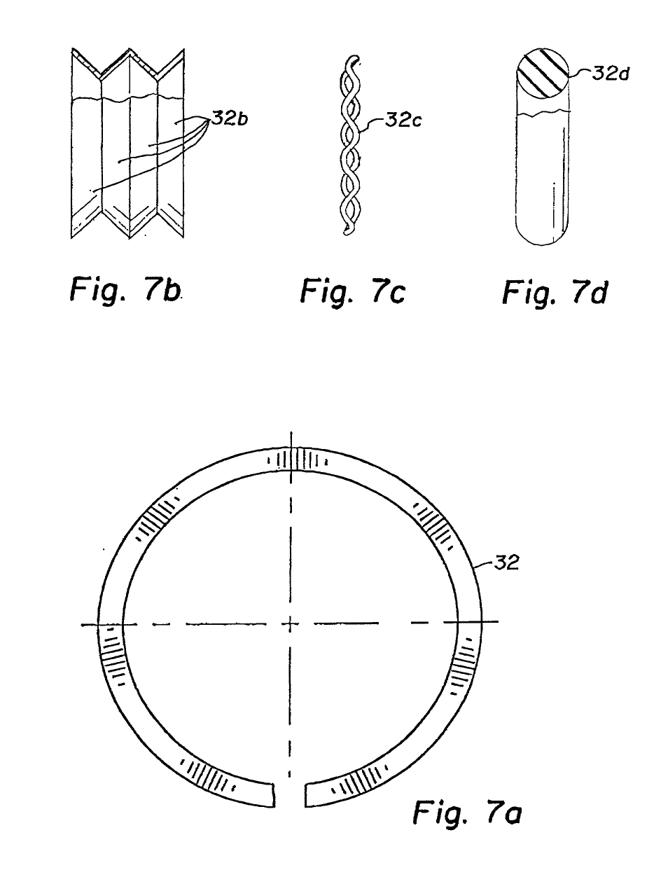

The use of the annular springs represents a significant improvement over prior methods. More than satisfactory in performance, the annular springs are safer and easier to install than ordinary coiled springs, and do not require that the driver plates be recessed to hold them in position. Shown in plan view in FIG. 7a is the wave spring embodiment 32 of the present inventions. Though the split configuration in this embodiment is preferred, it is not required by the present invention. In FIGS. 7b-d alternative embodiments of the annular spring of the present invention are illustrated. In FIG. 7b four belleville springs 32b are shown. Assembled in series. It is envisioned that one or more than four belleville springs (or other types of annular springs) could be used as required. For examples more than one wave springs could be used between each set of driver plates. In FIG. 7c wave shaped annular wire spring 32c is shown for use in clutch assemblies in place of wave springs. In FIG. 7d an annular resilient spring 32d is shown formed from elastomeric material or other suitable materials.

A stepped spacer ring 40 inserted substantially as shown in FIGS. 4-6 ensures that there is no unwanted lateral migration of the wave spring 32, where (as in FIGS. 5 and 6) a gap exists between the end of the hub splines 12 (including extended splines 38) and the back plate 6. (A perspective and a plan view of the spacer ring are shown in FIGS. 8a and 8b, respectively.) Although the stepped spacer ring is preferred, other configurations may be used as well. And in an alternate embodiment, a split spacer ring 41 such as the one shown in FIGS. 9a and 9b, can be used where installation could not be otherwise accomplished, such as in retrofit situations. The use of split ring 41 therefore permits the rebuilding of existing clutches to take advantage of the annular-spring technology.

Once the clutch 1 is assembled, air tube 27 is selectively inflated through inlet 27a and valve 30 to exert pressure on driver plates 13, 14, and 15 and friction plates 20, 21, and 22. As the pressure on the driver plates and friction plates is increased, friction forces between the driver plates and friction plates are sufficient to allow the friction plates to transmit rotary motion to the driving ring 18. It should be understood that clutch assembly 1 can be powered either through drive shaft 11, as described above, or through driving ring 18. If powered by the driving ring 18, the friction forces that develop between the driver plates and the friction plates allow the driver plates to impart rotary motion to the shaft 10.

Even though numerous characteristics and advantages of the present invention have been set forth in the foregoing description together with details of the structure and function of the invention, the disclosure is illustrative only. It should be understood that pneumatic clutch assembly could be used in many different applications requiring a wide range of torque ratings. In applications requiring a large torque rating, the number and/or diameter of the driver plates and the friction plates will increase. Likewise, in applications requiring a low torque rating the number and/or diameter of the driver plates and the friction plates may decrease. Various changes may be made in detail, especially in matters of shape, size, and arrangement of the parts, within the principles of the invention to the full extent indicated by the broad general meaning of the terms used. The restrictive description and drawings of the specific examples above do not point out what an infringement of this patent would be, but are to provide at least one explanation of how to make and use the invention. The limits of the invention and the bounds of the patent protection are measured by and defined in the appended claims.

What is claimed:

1. A pneumatic clutch assembly comprising:
a hub including a cylindrical wall, the cylindrical wall having a plurality of splines and defining a longitudinally extending passage for receiving and engaging a drive shaft;
a flange fixedly attached to the hub at a first end and having a substantially flat annular surface;
a driver plate concentrically disposed about the cylindrical wall and splined to the cylindrical wall on the splines;
at least one driven element disposed between the annular flange surface and the driver plate;
An annular spring concentrically disposed about the cylindrical wall between the flange and the driver plate;
means to engage the clutch by urging the driver plate toward the flange to frictionally engage the driven element;
a removable holding plate for securing at a second end of the hub in order to capture the driver plate, annular spring, driven element, and urging means, the holding plate being movable between a first position wherein the annular spring is substantially uncompressed and a second position wherein the annular spring has been substantially compressed to its operational configuration; and
wherein in at least one spline extends along the cylindrical wall for the uncompressed bias dimension required to substantially engage the driver plate when it is biased into position by the substantially uncompressed annular spring.

2. A pneumatic clutch assembly according to claim 1, further including a pressure plate concentrically disposed about the cylindrical wall and interposed between the holding plate and the driver plate.

3. A pneumatic clutch assembly according to claim 1 wherein the annular spring is a wave spring.

4. A pneumatic clutch assembly according to claim 1 wherein the annular spring is a belleville spring.

5. A pneumatic clutch assembly according to claim 1 wherein the annular spring is a wire spring.

6. A pneumatic clutch assembly according to claim 1 wherein the annular spring is a resilient spring.

7. A pneumatic clutch assembly according to claim 2, wherein said means to urge comprises:
an inflatable tubular member interposed between the pressure plate and the holding plate for selectively applying pressure to said driver plate; and
means for inflation in fluid communication with the tubular member.

8. A pneumatic clutch assembly according to claim 1, further comprising a plurality of driver plates, wherein the uncompressed bias dimension extends to the outermost driver plate when the clutch is in its alignment configuration.

9. A pneumatic clutch assembly according to claim 8, further comprising a plurality of annular springs, at least one of which is interposed between any two of the plurality of driver plates.

10. A pneumatic clutch assembly according to claim 1, wherein the driven element comprises:
a driven plate concentrically disposed about the cylindrical wall and between said driver plate and said flange; and
a driving ring concentrically disposed about the driven plate and having a second plurality of longitudinally extending splines facing inwardly toward the driven plate, the driven plate slideably disposed in the second plurality of alpines.

11. A pneumatic clutch assembly according to claim 1, further comprising a spacer ring to restrict lateral movement of the annular spring.

12. A pneumatic clutch assembly according to claim 11, where the spacer ring is a split spacer ring.

13. A clutch assembly, comprising:
a cylinder forming a longitudinally extending passage for receiving and engaging a drive shaft;
a back plate fixedly attached to a first end of the cylinder and having a substantially flat annular surface;
a plurality of longitudinal splines extending outwardly from said cylinder;
a floating plate concentrically disposed about the cylinder and splined to the cylinder on the splines;
an annular spring concentrically disposed about the cylinder and captured between the back plate and the floating plate;
a driven plate disposed between the back plate and the floating plate;
means to urge the floating plate toward the back plate to frictionally engage said driven plate;
a driving ring having a second plurality of splines, the driven plate being slideably disposed on the splines; and
a removable holding plate secured at a second end of the cylinder for capturing the floating plate and the driven plate, the holding plate being movable between an alignment configuration and an operational configuration.

14. A clutch assembly according to claim 13, further including a pressure plate interposed between the holding plate and the floating plate, the pressure plate concentrically disposed about said cylinder.

15. A pneumatic clutch assembly according to claim 13 wherein the annular spring is a wave spring.

16. A pneumatic clutch assembly according to claim 13 wherein the annular spring is a belleville spring.

17. A pneumatic clutch assembly according to claim 13 wherein the annular spring is a wire spring.

18. A pneumatic clutch assembly according to claim 13 wherein the annular spring is a resilient spring.

19. A clutch assembly according to claim 13, wherein the means to urge the floating plate includes an inflatable tubular ring interposed between the pressure plate and the holding plate for selectively applying pressure to the floating plate.

20. A clutch assembly according to claim 13, further including a plurality of floating plates.

21. A clutch assembly according to claim 20, further including a plurality of driven plates interposed between the plurality of floating plates.

22. A clutch assembly according to claim 13, further comprising a spacer ring.

23. A pneumatic clutch assembly comprising:
a hub including a cylindrical wall, the cylindrical wall having a plurality of splines and defining a longitudinally extending passage for receiving and engaging a drive shaft;
a flange fixedly attached to the hub at a first end and having a substantially flat annular surface
a driver plate concentrically disposed about the cylindrical wall and splined to the cylindrical wall on the splines;
at least one driven element disposed between the annular flange surface and the driver plate;
an annular spring concentrically disposed about the cylindrical wall between the flange and the driver plate to bias the driver plate into a spaced relationship when the clutch is in its alignment configuration;
means to urge said driver plate toward said flange to frictionally engage said driven element; and
a removable holding plate for securing at a second end of the hub in order to capture the driver plate, driven element, and urging means.

24. A pneumatic clutch assembly according to claim 23, further comprising a spacer ring.

25. A pneumatic clutch assembly according to claim 23, wherein the holding plate is moveable between an alignment configuration where the wave spring is substantially uncompressed and an operational configuration where the annular spring is substantially compressed, and further comprising a plurality of splines on the cylindrical wall extending substantially over the uncompressed bias dimension.

26. A pneumatic clutch assembly according to claim 23 wherein the annular spring is a wave spring.

27. A pneumatic clutch assembly according to claim 23 wherein the annular spring is a belleville spring.

28. A pneumatic clutch assembly according to claim 23 wherein the annular spring is a wire spring.

29. A pneumatic clutch assembly according to claim 23 wherein the annular spring is a resilient spring.

30. A clutch assembly, comprising:
a cylinder forming a longitudinally extending passage for receiving and engaging a drive shaft;
a back plate fixedly attached to a first end of the cylinder and having a substantially flat annular surface;
a plurality of longitudinal splines extending outwardly from said cylinder;
a floating plate concentrically disposed about the cylinder and splined to the cylinder on the splines;
a annular spring concentrically disposed about the cylinder and captured between the back plate and the floating plate;
a driven plate disposed between the back plate and the floating plate;
means to urge the floating plate toward the back plate to frictionally engage said driven plate;
a driving ring having a second plurality of splines, the driven plate being slideably disposed on the splines; and
a removable holding plate secured at a second end of the cylinder for capturing the floating plate and the driven plate.

31. A clutch assembly according to claim 30, further comprising a spacer ring.

32. A clutch assembly according to claim 30, further including at least one air passageway formed in the cylindrical wall, back plate and holding plate for cooling of the clutch assembly.

33. A clutch assembly according to claim 32, wherein the holding plate is movable between a alignment configuration where the annular spring is substantially uncompressed and an operational configuration where the annular spring is substantially compressed; wherein a plurality of extended splines on the cylinder extend substantially over an uncompressed bias dimension, and wherein the extended splines are provided adjacent the air passageway.

34. A pneumatic clutch assembly according to claim 30 wherein the annular spring is a wave spring.

35. A pneumatic clutch assembly according to claim 30 wherein the annular spring is a belleville spring.

36. A pneumatic clutch assembly according to claim 30 wherein the annular spring is a wire spring.

37. A pneumatic clutch assembly according to claim 30 wherein the annular spring is a resilient spring.
